(19) United States
(12) Patent Application Publication
(10) Pub. No.: US 2015/0135548 A1
(43) Pub. Date: May 21, 2015

(54) DEVICE FOR DRYING AT LEAST ONE OPTICAL GLASS

(71) Applicant: SCL INTERNATIONAL SPECIAL COATING LABORATORY, Archamps (FR)

(72) Inventors: Jean Gehrig, Viry (FR); Denis Gehrig, Saint-Julien en Genevois (FR)

(21) Appl. No.: 14/403,169

(22) PCT Filed: May 23, 2013
(86) PCT No.: PCT/FR2013/051116

§ 371 Date: Jan. 30, 2015

(30) Foreign Application Priority Data
May 24, 2012 (FR) 12/54805

(51) Int. Cl. F26B 21/00; F26B 23/06; F26B 25/06

(52) U.S. Cl. CPC F26B 21/004; F26B 25/06; F26B 23/06
USPC 34/89; 34/218

(57) ABSTRACT

The invention relates to a device (3) for drying at least one optical glass, comprising: a chamber (7), intended to house at least one optical glass, having at least one air inlet (19) arid at least one air outlet (29); a circuit (9) for circulating air, arranged to blow a flow of drying air from said at least one inlet (19) to said at least one outlet (29), the drying device has: an evacuation orifice (11), in fluid communication with the chamber (7), in order to evacuate a first portion of the flow of drying air, called the evacuated airflow, out of the drying device (3); and a manifold collecting: an inflow of a second portion of the flow of drying air, called recovered air, in fluid communication with the chamber (7), from said at least one air outlet (29); an inflow of a flow (33) of air from outside the drying device (3); and having an outlet (29) in fluid communication with the circulating circuit (9).

### TECHNICAL FIELD

The present invention relates to a device for drying optical glass.

### BACKGROUND

It is known to use a drying device composed of an enclosure intended to receive the optical glass or glasses. According to the state of the art, a heating element emitting infrared rays causes a temperature increase in the enclosure. The high temperature in the enclosure drives the drying process. According to the state of the art, the minimum heating temperature has to be over 80° C.

The surface treatment of an optical glass is conducted in several steps. The optical glass undergoes several dryings during the process of surface treatment, particularly after the washing, after application of a first layer of varnish and after application of a possible second layer of varnish.

During the drying carried out after the washing, the increase in temperature allows degassing of the optical glass. The dryings carried out after the application of a first layer of varnish and after the application of a second layer of varnish have the role of pre-polymerizing the varnish.

However, obtaining a uniform heating temperature throughout the entire surface of the optical glass is not evident with a device having an infrared ray emitter. According to the state of the art, less heated areas may appear, in particular for the furthest part of the glass from the infrared emitter.

During the drying carried out after the application of the first layer of varnish, there may be areas where the varnish is not fully pre-polymerized. This phenomenon is characterized by the formation of a white haze in the layer of varnish.

During the drying carried out after the application of the second layer of varnish, fingerprints may arise at the time of the removal of the glass out of the device. Surface irregularities are likely to appear on the glass, which may extend to cracking of the varnish.

As a consequence, if one of these defects appear, the glass has severely degraded optical properties.

### BRIEF SUMMARY

The present invention aims to overcome all or some of the drawbacks mentioned above.

For this reason, the present invention relates to a drying device for at least one optical glass, comprising:
an enclosure intended to house at least one optical glass, having at least one air inlet and at least one air outlet,
an air circulation circuit arranged for blowing a drying air stream from said at least one inlet to said at least one outlet,

the drying device being characterized in that it presents:
an exhaust port, in fluid communication with the enclosure so as to exhaust a first portion of the drying air stream, called exhaust air stream, outside of the drying device,
a manifold presenting:
an intake of a second portion of the drying air stream, called return air, in fluid communication with the enclosure from said at least one air outlet,
an intake of an external air stream to the drying device,
an outlet in fluid communication with the circulation circuit.

The manifold and the circulation circuit carry out a partial recycling of the drying air stream.

According to one aspect of the invention, the device further comprises a support of the at least one optical glass, the support being disposed inside the enclosure and being arranged so that the incident and emergent surfaces of each optical glass present each an area of contact with the air contained by the enclosure.

According to one aspect of the invention, each inlet of the enclosure has a diffuser arranged to generate an air flow that is homogeneous and tangential to the incident and emergent surfaces of each optical glass.

The drying is uniform on the incident and emergent surface of the optical glass in order to prevent the occurrence of a defect.

According to one aspect of the invention, the enclosure has a first and a second inlet arranged so that the flow of the first inlet is parallel and opposite to the flow of the second inlet.

The obtained symmetric structure allows rapid and uniform drying of the optical glass.

According to one aspect of the invention, each diffuser includes a planar outlet perforated with a plurality of holes, the distance between the centers of two adjacent holes being comprised between one and three times the hole diameter, the diameter of each hole being comprised between 0.5 and 3 mm.

The plurality of holes at the outlet of each diffuser has an aeraulic effect aimed at achieving a homogeneous flow.

According to one aspect of the invention, means for regulating the flow rates of the external air stream and of the return air stream are arranged so as to modify the proportion of the external air stream, relative to the set including the external air and return air streams, between 0 and 100%.

The drying residues originating from the optical glass or glasses are again mixed with the drying air. A high concentration of residues can make the air inflammable. The addition of external air in the circuit limits the concentration of residues.

According to one aspect of the invention, means for regulating the temperature of the drying air stream include a probe for measuring the temperature and a heating element in contact with the drying air stream.

The temperature should be comprised within a defined field in order to allow proper drying of the optical glass or glasses, typically between 80 and 110° C.

According to one aspect of the invention, a system for opening the enclosure is arranged in order to allow passage of an optical glass.

According to one aspect of the invention, the exhaust port of the enclosure of the drying device is comprised in the opening system.

According to one aspect of the invention, the opening system comprises at least one flap, the exhaust port being disposed at the periphery of the flap.

According to one aspect of the invention, a surface treatment bench of said at least one optical glass includes:
a suction hood provided with means for extracting air and vapors out of the treatment bench from an extraction area of the treatment bench,
the drying device, in which the exhaust port is in fluid communication with the extraction area, the pressure of the extraction area is lower than the pressure in the enclosure.

The stream exhausted from the drying device in the extraction area is suctioned by the hood and extracted out of the treatment bench. The air loaded with steam, possibly inflammable, does not stagnate in the treatment bench.

### BRIEF DESCRIPTION OF THE DRAWINGS

In any case, the invention will be understood from the following description with reference to the accompanying schematic drawings representing, by way of non-limiting example, an embodiment of this device.

FIG. 1 is a diagram of a device for drying at least one optical glass.

FIG. 2 is a detail of a front view of a surface treatment bench.

FIG. 3 is a perspective view of an enclosure of the drying device.

FIG. 4 is a partial perspective view of the enclosure of the drying device.

### DETAILED DESCRIPTION

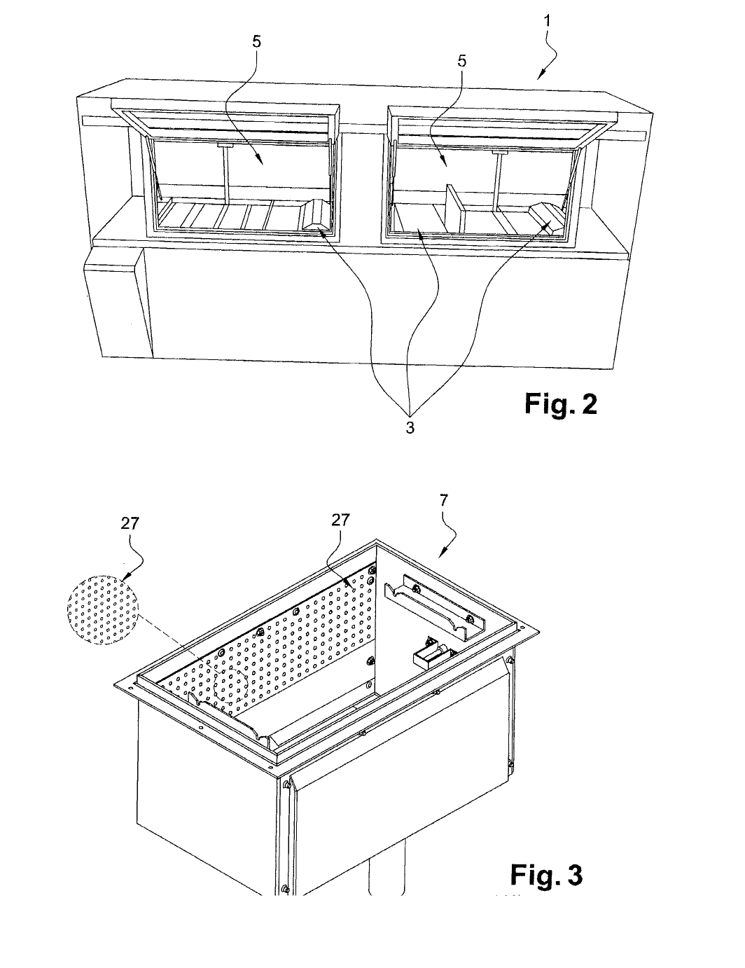

According to an embodiment described in FIG. 2, a surface treatment bench 1 includes a drying device 3 and an extraction area 5.

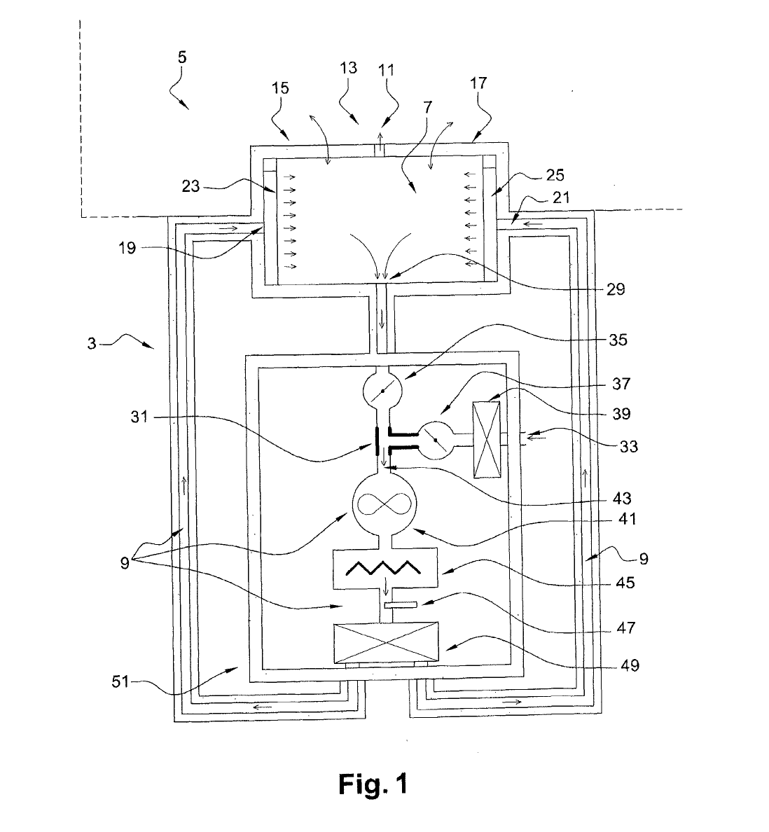

As shown more particularly in FIG. 1, the drying device 3 comprises an enclosure 7 and an air circulation circuit 9.

According to an embodiment described in FIG. 1, an exhaust port 11 connects the enclosure 7 to the extraction area 5 in fluid communication. An opening system 13 between the enclosure 7 and the extraction area 5 includes two raisable flaps 15 and 17. The gap between the two raisable flaps 15 and 17 constitutes the exhaust port 11.

The air circulation circuit 9 is connected in fluid communication with two air inlets 19 and 21 to the enclosure 7. Each air inlet 19 and 21 has a diffuser 23 and 25 respectively. According to an embodiment, the diffusers have a planar outlet with a plurality of holes 27 as shown more particularly in FIG. 3. The distance separating the centers of two adjacent holes is between one time and three times the hole diameter, the diameter of each hole being comprised between 0.5 and 3 mm. According to an embodiment described in FIG. 3, the holes 27 produce a regular grid of the outlets of the diffusers 23 and 25.

According to an embodiment described in FIG. 1, the enclosure 7 presents an air outlet 29 in fluid communication with a manifold 31. The manifold 31 is also in fluid communication with an intake of an external air flow 33 and the circulation circuit 9. A first valve 35 is located on the communication channel between the outlet 29 and the manifold 31 and a second valve 37 between the intake of an external air flow 33 and the manifold 31. The first 35 and the second valve 37 are adjustable between a first position corresponding to a full closing and a second position corresponding to a full opening.

According to an embodiment described in FIG. 1, a pre-filter 39 is located on the fluid communication channel between the intake of an external air flow 33 and the second valve 37.

According to an embodiment described in FIG. 1, the circulation circuit 9 comprises the following elements that are aligned and in fluid communication:
a fan 41 arranged such that the suction is connected in fluid communication to an outlet of the manifold 43,
a heating element 45 connected to the discharge of the fan 41,
a probe for measuring the temperature 47,
a high-temperature filter 49.

According to an embodiment described in FIG. 1, the air circulation circuit 9, as well as the collector 31, the first valve 35, the second valve 37 and the pre-filter 39 are included in an air treatment unit 51.

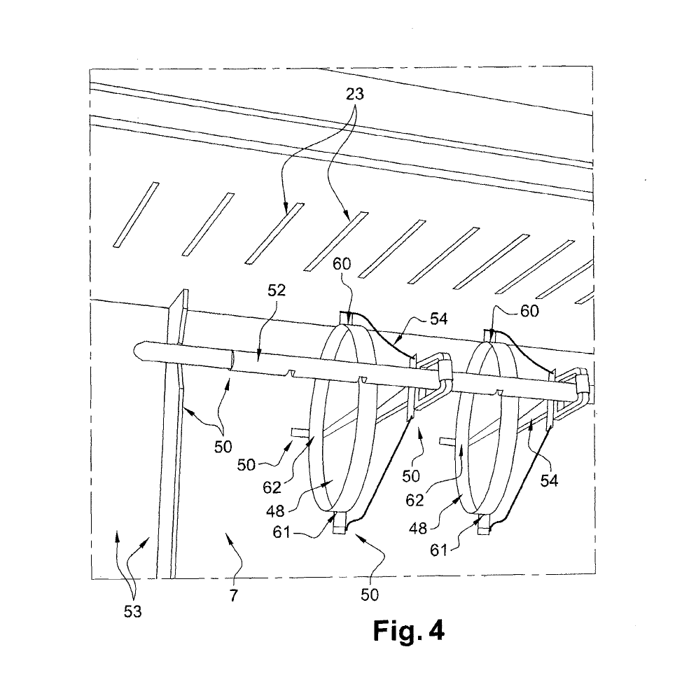

According to a mode of operation, the flaps 15 and 17 are raised in order to allow the introduction of an optical glass 48 previously varnished in the enclosure 7. As illustrated in FIG. 4, the optical glass or glasses 48 are disposed on a support 50 in the enclosure in such a way that the drying air flow originating from the diffusers is homogeneous and tangential to the incident and emerging surfaces of each optical glass 48. The support 50 comprises a rod 52 disposed horizontally inside the enclosure 7 on two uprights 53 integral with the wall of the enclosure 7. The support 50 also comprises a plurality of hooks 54 disposed on the rod 52. Each optical glass 48 is held in position by three contact points 60, 61, 62 to a hook 54 of the support 50. The enclosure 7 is provided with an outlet 29 through which a return air stream escapes.

According to a mode of operation described in FIGS. 1 and 2, the return air transits through an air treatment unit 51. A fan 41 causes the circulation of the return air flow. An external air stream is also suctioned through the fan 41. The recirculated air relative to the external air is regulated by two valves 35 and 37. At the discharge of the fan 41, the air stream composed of the return air stream and the external air stream forms the drying air stream. The drying air stream is reheated by a heating element 45, then filtered by a high-temperature filter 49. Finally the drying air is expelled out of the circulation circuit 9 in the enclosure by the diffusers 23 and 25. The flow of drying air originating from the diffusers is homogeneous and tangential to the incident and emergent surfaces of each optical glass 48. A portion of the drying air is then recycled as return air according to the process described above.

According to a mode of operation, the optical glass 48 disposed in the enclosure 7 of the drying device 3 is exposed to a drying air stream at a determined temperature for a determined period in order to become completely dry. The optical glass 48 is then removed from the enclosure 7.

It goes without saying that the invention is not only limited to the sole embodiment of this device, described above by way of example, it encompasses on the contrary all the alternative embodiments.

1. A device for drying at least one optical glass, comprising:
an enclosure, intended to house at least one optical glass, having at least one air inlet and at least one air outlet.
an air circulation circuit arranged for blowing a drying air stream from said at least one inlet to said at least one outlet,
an exhaust port, in fluid communication with the enclosure so as to exhaust a first portion of the drying air stream, called exhaust air stream, outside of the drying device, and
a manifold comprising:
an intake of a second portion of the drying air stream, called return air, in fluid communication with the enclosure from said at least one air outlet,
an intake of an external air flow to the drying device,
an outlet in fluid communication with the circulation circuit.

2. The device according to claim 1, further comprising a support for the at least one optical glass, the support being disposed inside the enclosure and being arranged so that the incident and emerging surfaces of each optical glass present each an area of contact with the air contained by the enclosure.

3. The drying device according to claim 1, wherein each inlet of the enclosure has a diffuser arranged to generate an air flow that is homogeneous and tangential to the emerging and incident surfaces of each optical glass.

4. The drying device according to claim 3, wherein the enclosure has a first and a second inlet arranged so that the flow of the first inlet is parallel and in opposite direction to the flow of the second inlet.

5. The drying device according to claim 3, wherein each diffuser includes a plane outlet perforated with a plurality of holes, the distance separating the centers of two adjacent holes being between one time and three times the hole diameter, the diameter of each hole being comprised between 0.5 and 3 mm.

6. The drying device according to claim 1, further comprising means for regulating the flow rates of the external air stream and return air stream are arranged so as to modify the proportion of the external air stream, relative to the set consisting of external air and return air streams, between 0 and 100%.

7. The drying device according to claim 1; further comprising means for regulating the temperature of the drying air stream including a probe for measuring the temperature and a heating element in contact with the drying air stream.

8. The drying device according to claim 1, wherein an opening system of the enclosure is arranged in order to allow the passage of an optical glass.

9. The drying device according to claim 8, wherein the exhaust port of the enclosure of the drying device is included in the opening system.

10. The drying device according to claim 9, wherein the opening system comprises at least one flap, the exhaust port being disposed at the periphery of the flap.

11. A surface treatment bench of said at least one optical glass including:
a suction hood provided with means for extracting air and vapors out of the treatment bench from an extraction area of the treatment bench,
the drying device, according to claim 1, wherein the exhaust port is in fluid communication with the extraction area, the pressure of the extraction area is lower than the pressure in the enclosure.
